(19) United States
(12) Patent Application Publication
(10) Pub. No.: US 2011/0321068 A1
(43) Pub. Date: Dec. 29, 2011

(54) Disk chucking device and motor apparatus using the same

(75) Inventors: Kyung Su Park, Suwon (KR); Pyo Kim, Suwon (KR)

(73) Assignee: SAMSUNG ELECTRO-MECHANICS CO., LTD., Suwon (KR)

(21) Appl. No.: 13/064,765

(22) Filed: Apr. 13, 2011

(30) Foreign Application Priority Data
Jun. 29, 2010 (KR) 10-2010-0062292

(51) Int. Cl. G11B 17/028

(52) U.S. Cl. 720/704; G9B/17.006

(57) ABSTRACT

There is provided a disk chucking device including a disk chucking device including a centering case to which an inner circumferential surface of a disk is fixed, chucking members received in insertion holes formed in the centering case, and an elastic member connecting the centering case and the chucking members to each other in such a manner as to elastically support the inner circumferential surface of the disk, when the disk is mounted on the centering case, the elastic member having at least two bent portions by which displacements and restoring forces have a quadratic function relationship.

### CROSS-REFERENCE TO RELATED APPLICATIONS

This application claims the priority of Korean Patent Application No. 10-2010-0062292 filed on Jun. 29, 2010, in the Korean Intellectual Property Office, the disclosure of which is incorporated herein by reference.

### BACKGROUND OF THE INVENTION

1. Field of the Invention

The present invention relates to a disk chucking device and a motor apparatus using the same, and more particularly, to a disk chucking device for providing users convenience and securing stability during the driving a disk, and a motor apparatus using the same.

2. Description of the Related Art

In general, a spindle motor installed in a disk driving device rotates a disk in such a manner that an optical pickup apparatus can read data recorded on the disk.

The disk is fixed to the spindle motor by a disk chucking device which rotates together with the spindle motor, and is repeatedly loaded onto and unloaded from the disk chucking device.

Herein, the inner circumferential surface of the disk is pressed by and mounted on the outer circumferential surface of a centering case of a disk chucking device. At this time, the center of both the disk and the centering case should be aligned with each other, so as to maintain the reliability of a disk chucking device in recording data on and reproducing data from the disk.

This means that data stored on the disk can be reproduced without any errors only when the rotary axis of a motor is correctly aligned with the rotary center of the disk.

However, in the prior art, after having been forcibly mounted in a centering case, the disk comes to have a reduced fixing force due to a restoring force of a spring. Thus, the disk is shaken during the rotation of a motor, which results in the unclear reproduction of data.

Also, the shaking of the disk caused by the rotation of the motor creates noises, such that it is impossible to implement stable driving of the disk.

Also, since the disk chucking device in the prior art maintains a linear relationship (that is, linear function) between restoring forces and displacements, chucking members was required to have a force corresponding to a large restoring force when the disk is mounted, and to have a force corresponding to a small restoring force when the disk is released.

Therefore, after having been mounted and rotated on the disk chucking device, the disk suffers from noise and vibrations due to the reduced restoring force of a spring. As a result, the stability of the disk chucking device in the prior art is reduced.

Therefore, there is a need to provide a technology for allowing a user to fix and release the disk with ease and implementing the reliability in the disk chucking device during the recording of data on or the reproduction from a disk, by reducing a difference between a fixing force and a releasing force for the disk.

### SUMMARY OF THE INVENTION

An aspect of the present invention provides a disk chucking device, by which a disk can be stably mounted even with a small force and driven without any shaking through the modification of a structure for an elastic member which provides an elastic force to a chucking member, thereby improving the reliability of a motor, and a motor apparatus using the same.

According to an aspect of the present invention, there is provided a disk chucking device including: a centering case to which an inner circumferential surface of a disk is fixed; chucking members received in insertion holes formed in the centering case; and an elastic member connecting the centering case and the chucking members to each other in such a manner as to elastically support the inner circumferential surface of the disk, when the disk is mounted on the centering case, the elastic member having at least two bent portions by which displacements and restoring forces have a quadratic function relationship.

The insertion holes may receive the chucking members, respectively, and the elastic member may be an integrally-formed leaf spring supporting the chucking members as being in contact with the chucking members.

The elastic member may be provided with contact portions, made by being into contact with the chucking members, the contact portions corresponding to a leaf spring bent toward the outer diameter thereof.

Each of the chucking members may include insertion grooves through which the contact portions are inserted.

The centering case may include claws elastically supporting the inner circumferential surface of the disk while being moved toward the inside of the centering case, when the disk is mounted on the centering case, the claws being interposed between the insertion holes, and the elastic members having the bent portions of being a leaf spring formed on the inside thereof corresponding to the claws.

The centering case may be sectioned by boundary walls therein in such a manner that the boundary walls are in contact with the chucking members, respectively, the boundary walls each having fixing grooves through which the elastic member is inserted to thereby be fixedly supported in the centering case.

The centering case may include fixing protrusions, and the fixing protrusions may be formed therein and fixedly supported by being in contact with the portions bent toward an inner diameter of the elastic member.

According to another aspect of the present invention, there is provided a motor apparatus including: a rotor case rotating against a stator, the rotor case being fixedly installed and provided for the mounting of a disk; a centering case installed on an upper part of the rotor case, the centering case supporting an inner circumferential surface of the disk; chucking members received in insertion holes formed within the centering case; and an elastic member connecting the centering case and the chucking members to each other in such a manner that the chucking members elastically support the inner circumferential surface of the disk, the elastic member being formed to have at least two bent portions by which displacements and restoring forces have a quadratic function relationship.

The insertion holes may receive the respective chucking members respectively, and the elastic member may be an integrally-formed leaf spring to support the chucking members while being in contact with the chucking members.

The centering case may include claws elastically supporting the inner circumferential surface of the disk while being moved toward the inside of the centering case, when the disk is mounted on the centering case, the claws being interposed between the insertion holes, and the bent portions of the elastics member being a leaf spring formed on the insides thereof corresponding to the claws.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a cross-sectional view schematically illustrating a motor apparatus using a disk chucking device according to an embodiment of the present invention;

FIG. 2 is an exploded perspective view schematically illustrating a motor apparatus using a disk chucking device according to an embodiment of the present invention;

FIG. 3 is a plan view schematically illustrating a disk chucking device according to an embodiment of the present invention;

FIG. 4 is a bottom view schematically illustrating a disk chucking device according to an embodiment of the present invention;

FIG. 5 is a bottom view schematically illustrating a disk chucking device according to another embodiment of the present invention;

FIG. 6 is a view for explaining how an elastic member is elastically deformed when a disk is mounted on a chunking member provided on the disk chucking device according to an embodiment of the present invention;

FIG. 7 is a view for explaining how an elastic member is elastically deformed when a disk is mounted on a chunking member provided on the disk chucking device according to another embodiment of the present invention; and

FIG. 8 is a graph illustrating a relation between restoring forces and displacements of the disk chucking device according to an embodiment of the present invention.

### DETAILED DESCRIPTION OF THE PREFERRED EMBODIMENT

Exemplary embodiments of the present invention will now be described in detail with reference to the accompanying drawings. This invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions may be exaggerated for clarity, and the same reference signs are used to designate the same or similar components throughout.

In the drawings, the shapes and dimensions may be exaggerated for clarity, and the same reference numerals will be used throughout to designate the same or like components.

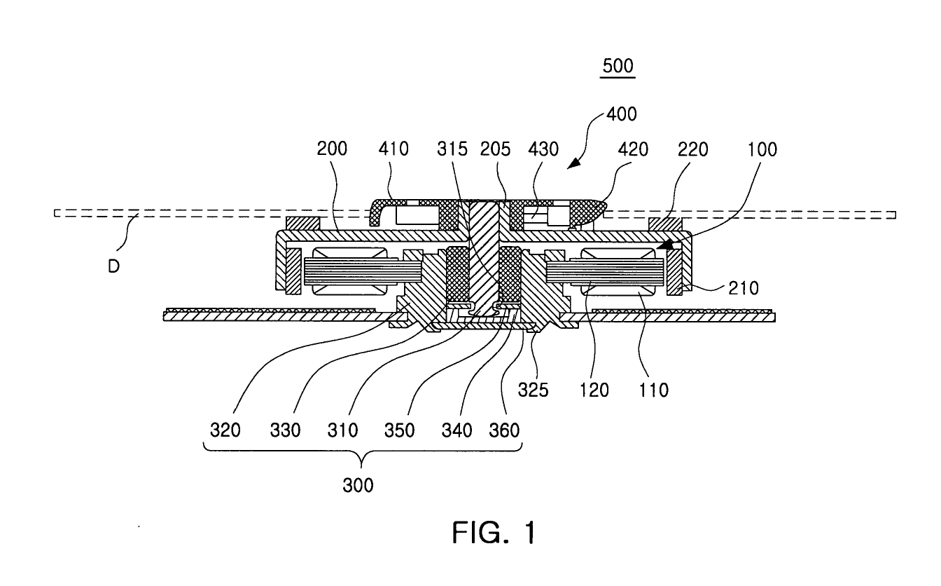

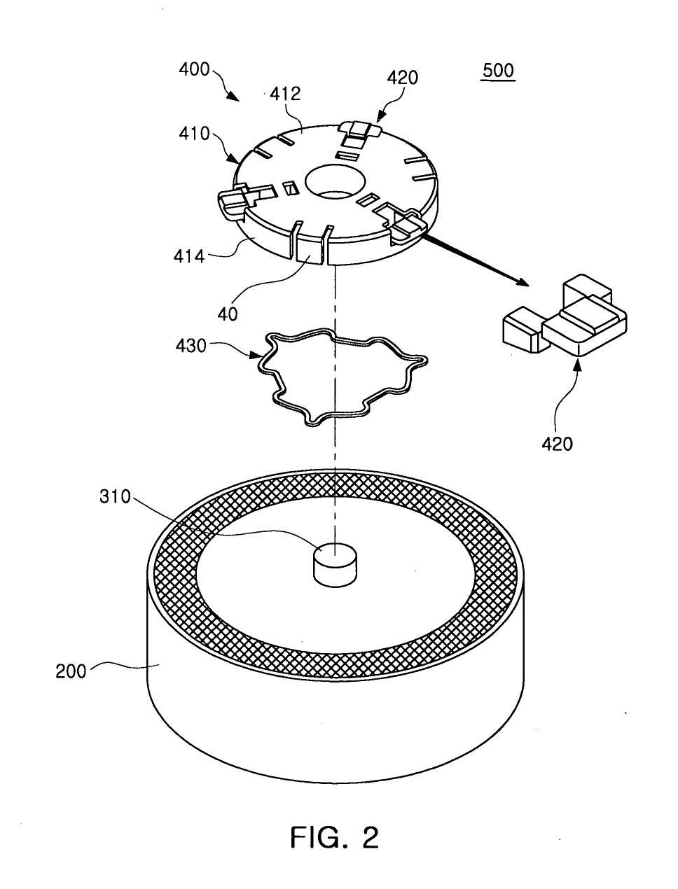

FIG. 1 is a cross-sectional view schematically illustrating a motor apparatus using a disk chucking device according to an embodiment of the present invention. FIG. 2 is an exploded perspective view schematically illustrating a motor apparatus using a disk chucking device according to an embodiment of the present invention.

Referring to FIGS. 1 and 2, a motor apparatus 500 according to an embodiment of the present invention may include a stator 100, a rotor case 200, a bearing assembly 300, and a disk chucking device 400.

The stator 100 is a stationary structure which includes winding coils 110 for generating an electromagnetic field having a predetermined force when a power supply voltage is applied thereto, and a plurality of cores 120 around which the winding coils 110 are wound.

Each of the winding coils 110 is electrically connected to a flexible printed circuit board (not shown) in such a manner that an external power supply voltage can be supplied thereto.

Herein, the stator 100 is coupled by a shaft 310, and magnets 210 disposed on an inside surface of the rotor case 200 are positioned to face the winding coils 110, respectively.

The rotor case 200 may be a rotary structure provided to rotate against the stator 100. On the inner circumferential surface of the rotor case may be provided the circular ring-shaped magnets 210 which correspond to the cores 120 with respect to a predetermined space therebetween.

And, the magnet 210 may be provided as a permanent magnet whose poles (N and S poles) are alternately magnetized in the cylindrical direction to thereby create an electromagnetic field having a predetermined strength.

At this time, a rotor hub 205 of the rotor case 200 coupled to the shaft 310 is formed in a longitudinal direction, and thus a contact surface therebetween is longitudinally formed as well, which results in an increase in a drawing force.

Also, the turntable 220 may be formed on the top surface of the rotor case 200 in such a manner as to be in contact with the bottom surface of a disk D when the disk D is seated thereon.

The turntable 220 may function to fixedly support the disk D through the creation of a friction force by which it is possible to prevent the disk D from slipping due to the driving of the motor.

The bearing assembly 300 may include a base 320, a shaft 310, a sleeve 330, and a thrust plate 340.

The base 320 may be assembled with the bearing assembly 300 by forcibly inserting its lower body into a receiving hole of the sleeve 330.

The base 320 may be provided with a shaft hole through which the shaft 310 is fitted thereto. The inside surface of the shaft hole may be provided with a plurality of radial dynamic pressure grooves.

The shaft 310 may be rotated in the shaft hole of the base 320, and longitudinally formed in a rotary axial direction.

Herein, the bottom surface of the shaft 310 is provided with the thrust plate 340 which reduces the friction force against the shaft 310 during the rotation of the motor apparatus.

One end of the shaft 310 contacted with the thrust plate 340 may be formed to have a curvature of radius.

A ring-shaped stopper 350 may be formed on the upper part of the thrust plate 340, and a ring-shaped holding part 315 depressed toward the central axis of the shaft 310 may be formed around the outer circumferential surface of the shaft 310 corresponding to the stopper 350.

The inner circumferential surface of the stopper 350 is inserted into the holding part 315, so that it is possible to prevent the departure of the shaft 310 in an upward direction of the sleeve 330.

On the lower part of the thrust plate 340 is positioned the supporting plate 360, which supports the shaft 310 as being coupled with the base 320.

The fixing of the supporting plate 360 may be carried out as follows. First, the supporting plate 360 is inserted into a lower part of the sleeve 330, and then the assembling protrusions 325 are bent with a strong force.

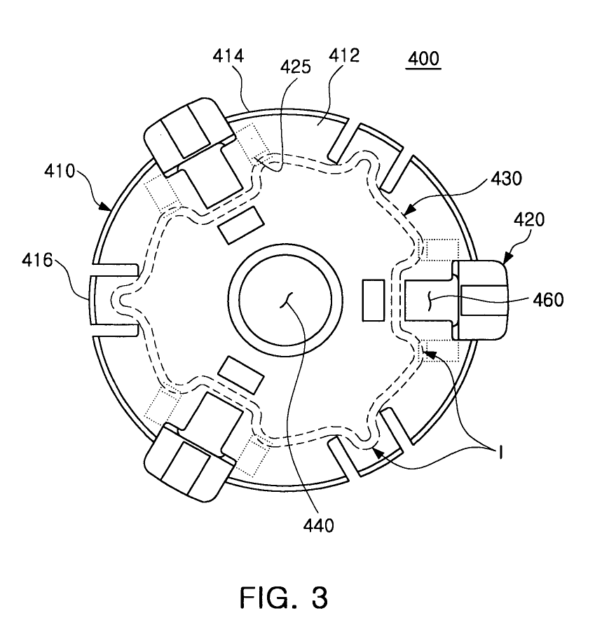

Hereinafter, the disk chucking device 400 will be described with reference to FIGS. 3 to 5.

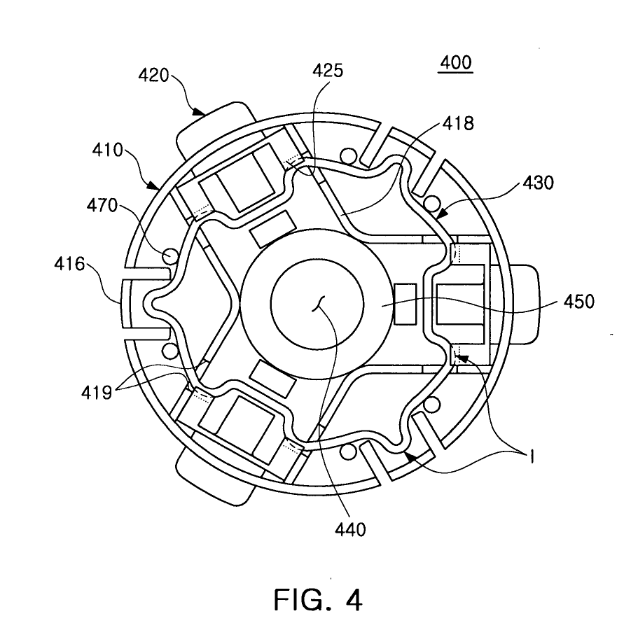

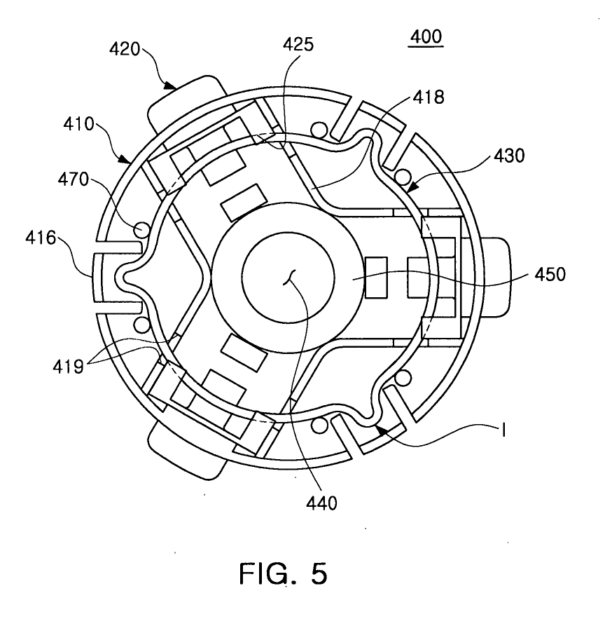

FIG. 3 is a plan view schematically illustrating a disk chucking device according to an embodiment of the present invention. FIG. 4 is a bottom view schematically illustrating a disk chucking device according to an embodiment of the present invention. FIG. 5 is a bottom view schematically illustrating a disk chucking device according to another embodiment of the present invention.

Referring to FIGS. 3 and 4, the disk chucking device 400 according to the embodiment of the present invention may include a centering case 410, chucking members 420, and an elastic member 430.

The centering case 410 may include a circular flat panel 412, and an outer circumference part 414 which extends to a downward axial direction from the edge of the outer circumferential surface the flat panel 412.

In particular, the centering case 410 may be disposed on the rotor case 200 with respect to the axial direction thereof. The centering case 410 may include a guide boss 450 with a boss hole through which the outer circumferential surface of the rotor hub 205 of the rotor case 200 is forcibly inserted.

Also, the centering case 410 is mounted on the upper part of the rotor case 200, and may include a plurality of insertion holes 460 each of which receives the respective chucking members 420 to be exposed to the outside.

Herein, the chucking members 420 may be inserted into the insertion holes 460 to be exposed to the outside. The elastic member 430 for providing an elastic force to the chucking members 420 may be coupled with the chucking members 420.

Also, the centering case 410 is provided with claws 416 which are interposed between the respective insertion holes 460. Each of the claws elastically supports the inner circumferential surface of the disk D while being moved toward the inside of the centering case 410, when the disk D is mounted thereon.

Each of the claws 416 may be formed with both sides being cut to be partially detached from the centering case 410, and prevent the departure of the disk D while supporting the chucking members 420 when the disk D is mounted.

The elastic member 430 may act as a member which connects the centering case 410 and the chucking members 420 to each other such that the chucking members 420 can elastically support the inner circumferential surface of the disk D, when the disk D is mounted on the disk chucking device 400 according to the embodiment of the present invention.

Herein, on the centering case 410 may be formed the insertion holes 460 through which the chucking members 420 may be received respectively.

Therefore, the elastic member 430 may be a leaf spring, which is formed as one body to support the chucking members 420 as being in contact with the chucking members 420.

Also, the elastic member 430 may be provided with at least two bent portions I, by which the restoring forces and the displacements may have a quadratic function.

Therefore, the elastic member 430 may be formed to have a plurality of bent portions, which support the chucking members 420 as being in contact with the chucking members 420.

Herein, portions of the elastic member 430 contacted with the chucking members 420 each may be bent toward the outer diameter thereof. Each of the chucking members 420 may have insertion grooves 425, through which the bent portions I are inserted and fixedly supported where the portions of the elastic member 430 are in contact with the respective chucking members 420.

The bent portions I of the elastic member 430 may be a leaf spring formed to correspond to internal portions which correspond to the claws 416 positioned to be spaced apart from one another with respect to the insertion holes 460.

Herein, the centering case 410 may have boundary walls 418 contacted with one side of each of the chucking members 420. Each of the boundary walls 418 may be positioned in a separate manner. Each of the boundary walls 418 may include fixing grooves 419 through which the elastic member 430 is inserted to be fixedly supported within the centering case 410.

Also, in the centering case 410 may be formed fixing protrusions, which fixedly support the elastic member 430 while being in contact with the portions of the elastic member 430 bent toward the inner diameter thereof.

Referring to FIG. 5, the disk chucking device 400 according to another embodiment of the present invention has the same features as those of the above-mentioned disk chucking device, except for an elastic member 430, and thus a repeated description thereof will be omitted.

The elastic member 430 may be formed to have bent portions and curved portions except for the bent portions, as shown in FIG. 5. The bent portions are bent toward the inside of the claws alone, respectively, and the remaining portions have curved edges.

Therefore, the chucking members 420 may be fixedly supported as being in contact with the remaining portions except for the bent portions I of the elastic member 430.

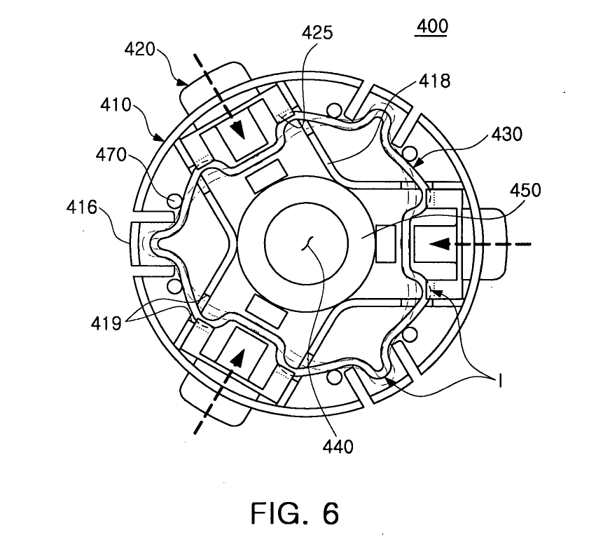

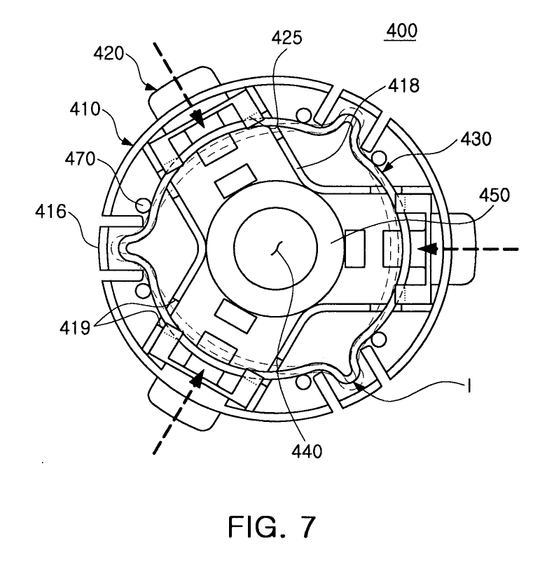

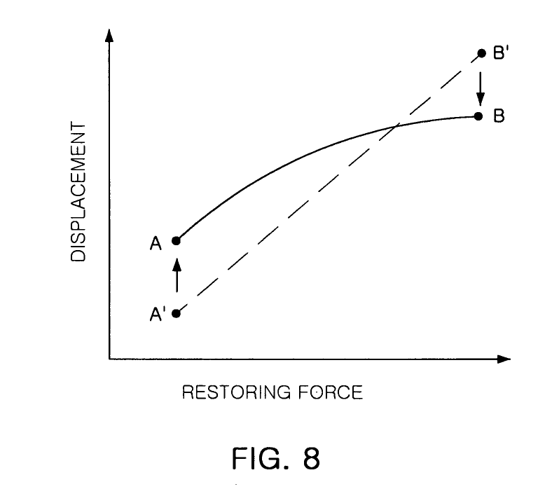

FIG. 6 is a view showing how an elastic member is elastically deformed when a disk is mounted on a chunking member in the disk chucking device according to an embodiment of the present invention. FIG. 7 is a view showing how an elastic member is elastically deformed when a disk is mounted on a chunking member in the disk chucking device according to another embodiment of the present invention. FIG. 8 is a graph illustrating a relationship between restoring forces and displacements of the disk chucking device according to an embodiment of the present invention.

Referring to FIGS. 6 and 7, when inserted into the disk chucking device 400 according to the embodiment of the present invention, the disk D moves the chucking members 420 toward the inside of the centering case 410 through the insertion holes 460, as shown in an arrow mark in FIGS. 6 and 7.

Herein, as being moved toward the inside of the centering case 410, the chucking members 420 pressurize the elastic member 430. The elastic force resulting from the pressurization produces a restoring force, returning to its original position, and thus the resultant restoring force is applied to the chucking members 420, which results in the immobilization of the disk D.

However, in this case, the bent portions I positioned inside the claws 416 are slightly moved toward the outer diameter of the centering case 410 by the movement of the chucking members 420.

Referring to FIG. 8, it can be seen that the relationship between the restoring forces and the displacements of the disk chucking device 400 may have a quadratic function with a curved shape.

Herein, A denotes a restoring force of the elastic member 430 when the disk D is demounted from the disk chucking device 400, and B denotes a restoring force of the elastic member 430 when the disk D is mounted thereon.

In contrast, A′ denotes a restoring force of an elastic member at the moment when a disk is demounted from the conventional disk chucking device, and B′ denotes a restoring force of an elastic member when a disk is mounted thereon.

In this case, as shown in FIG. 8, it can be seen that A has a larger restoring force than that of A′, and B has a smaller restoring force than that of B′, with respect to the same displacement.

Therefore, the disk chucking device 400 according to the embodiment of the present invention is structured to have an elastic member 430 with at least two of its bent portions, thereby reducing a restoring force when the disk D is mounted thereon, and increasing a restoring force when the disk D is demounted.

As described above, according to the embodiment of the present invention, when the disk D is mounted, it is possible to reduce a restoring force of the elastic member 430, and thus to easily and smoothly mount the disk D. When the disk D is released; a restoring force of the elastic member is increased, and thus the disk D is fixed. Therefore, when the motor apparatus 500 is rotated, the chucking members 420 can stably support the disk D, thereby clearly reproducing information of the disk D and preventing the departure of the disk D due to an external impact.

Also, it is possible to reduce shaking of the disk D, and thus to reduce noise and vibrations as well, which results in an increase in the reliability of the motor apparatus 500.

According to the disk chucking device and the motor apparatus using the same of the present invention, it is possible to reduce a difference between restoring forces when the disk is mounted and demounted.

Also, a reduction in the difference between the restoring forces allows the disk to be mounted with ease and strongly fixed during the rotation of a motor.

Also, it is possible to increase a fixing force of the disk to thereby prevent noise and vibrations in the disk caused by shaking of the disk, which results in improvement in the reliability of the motor.

While the present invention has been shown and described in connection with the exemplary embodiments, it will be apparent to those skilled in the art that modifications and variations can be made without departing from the spirit and scope of the invention as defined by the appended claims.

What is claimed is:

1. A disk chucking device comprising:
a centering case to which an inner circumferential surface of a disk is fixed;
chucking members received in insertion holes formed in the centering case; and
an elastic member connecting the centering case and the chucking members to each other in such a manner as to elastically support the inner circumferential surface of the disk, when the disk is mounted on the centering case, the elastic member having at least two bent portions by which displacements and restoring forces have a quadratic function relationship.

2. The disk chucking device of claim 1, wherein the insertion holes receive the chucking members, respectively, and the elastic member is an integrally-formed leaf spring supporting the chucking members as being in contact with the chucking members.

3. The disk chucking device of claim 1, wherein the elastic member is provided with contact portions, made by being into contact with the chucking members, the contact portions corresponding to a leaf spring bent toward the outer diameter thereof.

4. The disk chucking device of claim 1, wherein each of the chucking members includes insertion grooves through which the contact portions are inserted.

5. The disk chucking device of claim 1, wherein the centering case includes claws elastically supporting the inner circumferential surface of the disk while being moved toward the inside of the centering case, when the disk is mounted on the centering case, the claws being interposed between the insertion holes, and the elastic members having the bent portions of being a leaf spring formed on the inside thereof corresponding to the claws.

6. The disk chucking device of claim 1, wherein the centering case is sectioned by boundary walls therein in such a manner that the boundary walls are in contact with the chucking members, respectively, the boundary walls each having fixing grooves through which the elastic member is inserted to thereby be fixedly supported in the centering case.

7. The disk chucking device of claim 1, wherein the centering case includes fixing protrusions, and the fixing protrusions are formed therein, and fixedly supported by being in contact with the portions bent toward an inner diameter of the elastic member.

8. A motor apparatus comprising:
a rotor case rotating against a stator, the rotor case being fixedly installed and provided for the mounting of a disk;
a centering case installed on an upper part of the rotor case, the centering case supporting an inner circumferential surface of the disk;
chucking members received in insertion holes formed within the centering case; and
an elastic member connecting the centering case and the chucking members to each other in such a manner that the chucking members elastically support the inner circumferential surface of the disk, the elastic member being formed to have at least two bent portions by which displacements and restoring forces have a quadratic function relationship.

9. The motor apparatus of claim 8, wherein the insertion holes receive the respective chucking members respectively, and the elastic member is an integrally-formed leaf spring to support the chucking members while being in contact with the chucking members.

10. The motor apparatus of claim 8, wherein the centering case includes claws elastically supporting the inner circumferential surface of the disk while being moved toward the inside of the centering case, when the disk is mounted on the centering case, the claws being interposed between the insertion holes, and the bent portions of the elastic member being a leaf spring formed on the insides thereof corresponding to the claws.
